(19) United States
(12) Patent Application Publication
(10) Pub. No.: US 2014/0067473 A1
(43) Pub. Date: Mar. 6, 2014

(54) SYSTEMS AND METHODS FOR MEASURING AND SCORING THE EFFECTIVENESS OF A MESSAGE

(71) Applicant: John Nienstedt, SR., San Diego, CA (US)

(72) Inventor: John Nienstedt, SR., San Diego, CA (US)

(21) Appl. No.: 13/601,591

(22) Filed: Aug. 31, 2012

(51) Int. Cl. G06Q 10/00

(52) U.S. Cl. 705/7.32

(57) ABSTRACT

Methods of evaluating the effectiveness of a message in changing the opinion of a person are provided. A person's opinion on a position statement is obtained and given a numerical value, after which the person assesses several messages related to the position statement based on how convincing each message is to that person, assigning a numerical value to each message. The person's opinion on the position statement is then re-assessed, and for any person whose opinion has changed in a certain direction, the numerical values for each message are averaged to obtain an effectiveness score for each of the several messages.

### FIELD OF THE INVENTION

The present invention relates, in general, to assessing the effectiveness of a message in influencing a person, and more particularly to measuring the effect of a message, endorsement, biographical information or provision on a group of people and scoring the persuasive effect of a message.

### BACKGROUND OF THE INVENTION

Messages are used to convey ideas and often have an effect on a person of a particular point of view, whether the message is rooted in politics, advertising, public opinion or just a factual statement. The message may or may not be intended to have a particular effect, or it may have an effect not intended by the creator of the message. However, almost every statement has some type of effect on the recipient, whether it is intended to or not.

Many messages are created specifically with the purpose of having a particular effect on the recipient of the message, such as messages used in political campaigns, advertising slogans and public opinion campaigns, among others. Significant time, money and research is spent to create these types of messages, as their effect is critical to the success of a political candidate, a business selling a product or service, or an organization hoping to gain favorable public opinion for a project or cause. When such considerable effort is placed into generating the message, it is also wise to determine whether or not the message is effective in convincing a recipient of the substantive meaning of the message before the message is actually used. However, determining the effectiveness of a message is extraordinarily difficult, as it requires quantifying the subjective nature of a person's opinions and thought processes. Efforts to quantify the effectiveness of a message usually rely upon general, randomized opinion polling which only provides an indirect indication of a user's opinion as it relates to a message, or which may not be able to guarantee that the message has actually been heard by the recipient.

In addition, simply obtaining a person's opinion of a message may be irrelevant if that person is highly unlikely to change their opinion, or if that person is already in agreement with the goals of the messenger. In politics, marketing, public relations and other campaigns or situations where one party wants to change the opinion of a person or group of people, it is difficult to determine which individuals are likely to change their opinion and which are not.

There is therefore a need to determine the effectiveness of a message so that the creator of the message can better communicate with a target audience.

### SUMMARY OF THE INVENTION

Embodiments described herein are directed to measuring and scoring the effectiveness of a message by obtaining a numerical value of a survey respondent's opinion of a position statement, obtaining a numerical value of a survey respondent's opinion of at least one message, and/or obtaining a numerical value of a survey respondent's opinion of the at least one message, and providing an effectiveness score for the at least one message based on whether the survey respondent's opinion of the position statement changed after listening to the at least one message. In addition to a message, the effectiveness of an endorsement, a biographical statement or a provision may also be measured and scored by obtaining a numerical value of a survey respondent's opinion on a position statement, presenting the survey respondent with an endorsement, biographical statement or provision, obtaining a numerical value of the survey respondent's opinion of the endorsement, biographical statement or provision and then determining an effectivness score for the endorsement, biographical statement or provision based on whether the survey respondent's opinion of the position statement changed after listening to the at least one message. The message, endorsement, biographical statement and provision may be presented to the respondent together, but each message, endorsement, biographical statement and provision will receive a separate effectiveness score.

In one embodiment of the invention, a method of assessing the effectiveness of a message comprises obtaining a first opinion from a randomly selected group of respondents on a position statement; assigning a numerical value to each of the first opinions from the randomly selected group of respondents; obtaining an assessment from the randomly selected group of respondents of at least one message related to the position statement; assigning a numerical value to each assessment of each message from the randomly selected group of respondents; obtaining a second opinion from the randomly selected group of respondents on the position statement after the randomly selected group of respondents have assessed the at least one message; and calculating an effectiveness score of the at least one message based on a number of people in the randomly selected group of respondents whose opinions on the position statement changed from the first opinion to the second opinion.

In another embodiment, a system of measuring the effectiveness of a message comprises a first opinion assessment unit which obtains a first opinion from a plurality of respondents on a position statement and assigns a numerical value to each of the first opinions from the plurality of respondents; a message assessment unit which obtains an assessment from the plurality of respondents of at least one message related to the position statement and assigns a numerical value to each assessment of each message from the plurality of respondents; a second opinion assessment unit which obtains a second opinion from the plurality of respondents on the position statement after the plurality of respondents have assessed the at least one message; and a message effectiveness unit which calculates an effectiveness score of the at least one message based on a number of people in the plurality of respondents whose opinions on the position statement changed from the first opinion to the second opinion.

In a further embodiment of the invention, a computer program product embodied on a computer-readable medium comprises computer executable instructions for executing, on a computer with a processor and memory, a method of assessing the effectiveness of a message, comprising the steps of: obtaining a first opinion from a plurality of respondents on a position statement; assigning a numerical value to each of the first opinions from the plurality of respondents; obtaining an assessment from the plurality of respondents of at least one message related to the position statement; assigning a numerical value to each assessment of each message from the plurality of respondents; obtaining a second opinion from the plurality of respondents on the position statement after the plurality of respondents have assessed the at least one message; calculating an effectiveness score of the at least one message based on a number of people in the plurality of respondents whose opinions on the position statement changed from the first opinion to the second opinion; and displaying the effectiveness score of the at least one message on a display connected with the computer

From this description, in conjunction with other items, the advantages of the said invention will become clear and apparent more so based upon the hereinafter descriptions and claims, which are supported by drawings with numbers relating to parts, wherein are described in the following sections containing the relating numbers.

### BRIEF DESCRIPTION OF THE DRAWINGS

The accompanying drawings, which are incorporated in and constitute a part of the specification, illustrate embodiments of the invention and, together with the description, serve to explain the objects, advantages, and principles of the invention. In the drawings:

FIG. 1 is a flow diagram of a method of assessing the effectiveness of a message, according to one embodiment of the invention;

FIG. 2 is is a block diagram illustrating a system for assessing the effectiveness of a message, according to one embodiment of the invention; and

FIG. 3 is a block diagram that illustrates an embodiment of a computer/server system upon which an embodiment of the inventive methodology may be implemented.

### DETAILED DESCRIPTION OF PREFERRED EMBODIMENTS

After reading this description it will become apparent to one skilled in the art how to implement the invention in various alternative embodiments and alternative applications. However, all the various embodiments of the present invention will not be described herein. It is understood that the embodiments presented here are presented by way of an example only, and not limitation. As such, this detailed description of various alternative embodiments should not be construed to limit the scope or breadth of the present invention as set forth below.

The systems and methods described herein provide for an accurate and easy to understand numerical score which represents the effectiveness of a message in changing the opinion of a person on a particular issue. The systems and methods are useful for public opinion surveys on any type of issue, including politics, public policy issues, public relations campaigns, marketing campaigns, product evaluations, mock jury trials, etc.—essentially for any circumstance in which a party is interested in swaying the opinion of people or groups of people. The embodiments herein are effective at analyzing a number of different messages designed to change or affirm a person's opinion and providing a single metric that represents the effectiveness of that message. Numerous messages can be assessed at the same time and then easily compared based on the numerical score that represents the effectiveness of each message. Based on additional analytics, a range of numerical scores can be grouped into larger categories indicating an overall effectiveness of the message. The message may be further classified as an endorsement, a biographical statement or a provision of a proposition or ballot measure, although this list is not considered exhaustive by any means.

In any type of public opinion situation, such as a political campaign, a party interested in changing public opinion is not interested in changing every single person's opinion. A portion of the population already agrees with the party's opinion and does not need to be further persuaded. Another portion of the population already disagrees with the party's opinion and often cannot be persuaded to change their opinion regardless of the messages they hear. The key portion of the population is people who have an opinion but are open to changing their opinion when presented with a particular message. In a political campaign, this segment is known as persuadable voters.

Therefore, it is desireable to measure the effectiveness of a message on a person only if the person's opinion on a particular issue changed after they hear the message. The change in their opinion indicates that one or more of the messages tested were effective in changing their opinion.

### Obtaining First Opinions

In one embodiment, a plurality of people participating in a survey, otherwise termed “respondents,” are first provided with a position statement and asked to provide their opinion as to that position statement. For example, in a political campaign, a respondent may be asked if they are voting for Candidate A or Candidate B. They are then asked to select one answer among a limited group of answers that operate on a scale of opinion. In one embodiment, the user is asked to select one of five different answers, including:

Definitely Candidate A

Maybe Candidate A

Undecided/Not Sure

Maybe Candidate B

Definitely Candidate B

This is considered a first opinion on a position statement. These answers can then easily be assigned to a numerical value on a scale, such as a five point scale where:

“Definitely Candidate A”=1

“Maybe Candidate A”=2

“Undecided”=3

“Maybe Candidate B”=4

“Definitely Candidate B”=5

The number of choices available is not limited to five and could be either increased or decreased as needed. In addition, the numerical scale may also be changed to range from a negative two (−2) for “Definitely Candidate A” to a positive two (+2) for Definitely Candidate B. Furthermore, each answer may pertain to a range of numerical values, such that the total range of numerical values may be on a ten point scale from one to ten or a one hundred point scale from zero to one hundred. However, the goal is to measure whether a respondent's opinion has changed, so increasing the number of answers the respondent may give will increase the measurement of the degree of movement of the respondent's change in opinion. Having too few options (such as only 3 answers) may fail to capture a respondent's change in opinion if the respondent's opinion was partially, but not completely, changed if there is no answer that corresponds to that slight change. Providing between 5 and 7 answers has been shown to provide effective movement, although fewer questions or more questions may still be effective.

### Assessing Messages

Next, the respondent is asked to listen to a message which is related to the position statement. The message may be directly or indirectly related to the position statement, but the question is designed to have the respondent contemplate the message. The message could relate directly to information on Candidate A or B, or indirectly relate to one of the candidates, such as as statement about the health of the economy during Candidate A′s tenure as a currently elected official. The respondent is then asked to rate how convincing the message is, on a scale from very convincing to not convincing, such as:

Very Convincing

Somewhat Convincing

Undecided/Not Sure

Not Convincing

The respondent's assessment of each message can then be assigned a numerical value along a scale that corresponds to the options for how convincing the messages were. For example:

Very Convincing=2

Somewhat Convincing=1

Undecided/Not Sure=0

Not Convincing=−1

In another embodiment, the number of assessment levels may be the same, but they may each cover a range of numerical values to allow the levels to vary on a broader numerical scale and provide a more accurate numerical value for the message. For example, the numerical values of the messages may be rated by the respondents to be between 0-100 where zero is not at all convincing and 100 is extremely convincing. This scale may vary depending on the distribution of effectiveness scores desired. In another embodiment, a ten point scale from 1-10 could be used.

In one embodiment, the messages provided will be opposing to each other so that the respondent can evaluate a range of messages that are designed to have differing effects. For example, if the respondent is provided with 10 messages, 5 of those messages may be messages which ask the respondent how convincing the message is in persuading them to vote for Candidate A, while the other 5 messages may ask a respondent how convincing the message is in persuading them to vote for Candidate B. In this situation, half of the people taking the survey will be presented with the 5 messages supporting Candidate A, while all of the people taking the survey will be presented with the 5 messages supporting Candidate B first. This balances the number of messages heard by the respondents so that Candidate A would not have the advantage.

The messages should be carefully formulated to avoid introducing bias that would upset, cause fatigue or offend a respondent and cause inaccurate assessments. For example, a question which states “If you knew Candidate A cheated on his taxes, how would this affect your vote?” introduces an inherent presumption that perhaps Candidate A had cheated on his taxes. Instead, the question could be structured to state “Candidate A's opponents say that he cheated on his taxes. How does this affect your vote?” The messages should be carefully crafted so that they mimic real-world communications and should be limited to about 50 words.

### Assessing Endorsements, Biographical Information and Provisions

In addition to assessing messages, in one embodiment, another level of evaluation may be provided where respondents are provided with one or more statements regarding an endorsement of a position statement. For example, in the above example of the position statement about who a respondent is going to vote for (Candidate A or Candidate B), an endorsement statement will state “If you knew that the President supported Candidate A and urged you to vote for Candidate A, would you be more inclined or less inclinded to vote for Candidate A?” Multiple endorsement statements can be provided to the the respondents, with endorsements for each candidate or multiple endorsements by different people or organizations for the same candidate being provided. The endorsement statements may endorse any type of position statement, such as a proposition on a ballot measure, a company or product, an author, an organization, etc. In addition, the endorsements may be positive or negative in connotation—for example, the endorsement may be that the President opposes Candidate A (which may be more relevant if Candidate A is in the same political party as the President and would be assumed to be supporting Candidate A).

In another embodiment, a biographical information statement may be used where respondents are provided with one or more statements about a candidate or person that is directed to the candidate's biography. For example, in the above example of the position statement about who a respondent is going to vote for (Candidate A or Candidate B), a biographical statement will state “Candidate A is a war veteran,” after which the respondent is asked to evaluate whether that biographical information makes them more or less likely to vote for Candidate A. Multiple biographical statements can be provided to the the respondents, with biographical statements pertaining to each candidate or people connected with the candidate (a running mate or spouse, for example). Biographical statements may also be lengthier, for example about 75 words, and describe a general fact about a candidate's history that is generally dispassionate.

The endorsement statements and biographical statements may then be assessed similarly to the messages by asking the respondents to provide a scaled set of answers which are then assigned numerical values. The scales may be any one of the aforementioned levels of assessment, such as values between negative two (−2) and positive two (2), zero (0) to ten (10) or zero (0) to one hundred (100). A five-level evaluation scale for endorsements and biographical statements has been shown to provide an adequate level of choices for an endorsement without inducing confusion in the participant. In one embodiment, after listening to one or more endorsements or biographical statements, the participant is asked if they are more or less inclined to vote for a candidate based on the endorsement or biographical statement, and the answers are rated on the following scale from negative two (−2) to positive two (+2):

Much More Inclined=2

Somewhat More Inclined=1

Undecided/Not Sure=0

Somewhat Less Inclined=−1

Much Less Inclined=−2

In still another embodiment, a provision may be used, where respondents are provided with information on one or more parts of a ballot measure, proposition or electoral issue. For example, a respondent is given a position statement asking whether or not they would vote for Proposition B, after which their first opinions would be assessed as described above, only with the answers stating:

Definitely Vote Yes on Proposition B

Somewhat Vote Yes on Proposition B

Undecided/Unsure

Somewhat Vote No on Proposition B

Definitely Vote No on Proposition B

In this example, Proposition B is a measure to overhaul the retirement system for city workers. One or more provisions of Proposition B would then be given to the respondents, such as “Employees will contribute to their own retirement,” or “Taxpayers will help fund government employee benefits.” The respondents are then asked—for each provision—if the provision would make them more or less inclined to vote for Proposition B. In contrast with endorsements and biographical information, the scale of answers that the respondents select for the provisions category may be different. In one embodiment, the respondents answer the question about their inclination to vote by responding with:

Very Good Reason to Vote for Prop B

Somewhat Good Reason to Vote for Prop B

Unsure/No Difference

Somewhat Good Reason to Vote Against Prop B

Very Good Reason to Vote Against Prop B

These answers are then valued on a similar negative two (−2) to positive two (+2) scale as with the endorsements and biographical information.

The endorsements, biographical information and provisions provide a level of assessment that may be evaluated to determine the effectiveness of an endorsement, a piece of biographical information on a candidate, or a provision of a ballot measure, which is a common method used to persuade a person to change their opinion or position. In the following description, the presentation of one or more endorsements and one or more messages is described, although biographical information could also be included if desired. In another embodiment, only one type may be presented, such as a list of messages. However, if endorsements, messages or other types are presented together, each of them will each receive its own separate effectiveness score.

### Obtaining Second Opinions

Once the respondents have assessed the messages and the numerical scores have been assigned to the messages, and once the respondents have assessed the endorsements and the numerical scores have been assigned to the endorsements, the respondents are exposed to the position statement again and asked to provide a second opinion on the position statement. The respondents are asked who they are voting for again and provided with the same “Definitely Candidate A,” “Maybe Candidate A,” “Undecided/Not Sure,” “Maybe Candidate B,” and “Definitely Candidate B” answers as before. The important point to identify how the respondent's opinion has changed, if at all, as the key is to isolate the subset of respondents who were influenced by one or more of the messages or endorsements. This subset of respondents may be termed “movers,” as their opinions of the position statement have been moved in one direction or another by one or more of the messages or endorsements.

In one embodiment, the movers are further sub-divided based on the direction of their movement, as movers who moved toward Candidate A and movers who moved toward Candidate B, for example, necessarily found different messages and endorsements more convincing than the other. For example, for messages in support of Candidate A, only the assessments of those who moved toward Candidate A or away from Candidate A are used to compute the effectiveness score. Similarly, for messages in support of Candidate A, only the assessments of those who moved toward Candidate A or away from Candidate A are used to compute the effectiveness score. In one embodiment, respondents who moved away from Candidate A may be used to determine the effectiveness score of messages and endorsements supporting Candidate A if the movers in the opposing direction of Candidate A produced a negative score for a message. That negative score is subtracted from the score produced by the movers that moved toward Candidate A when calculating the effectiveness score.

In another embodiment, the group of respondents may be presented with messages and endorsements which can be sub-divided into messages and endorsements supporting Candidate A and opposing Candidate A—essentially “positive” messages and endorsements and “negative” messages and endorsements. In this situation, an effectiveness score would be determined for the positive messages and endorsements by looking at the assessment scores of respondents who moved toward Candidate A from their first opinion to their second opinion, as it is likely that the positive messages and endorsements influenced them to further support Candidate A. Similarly, an effectiveness score would be determined for the negative messages and endorsements by looking at the assessment scores of respondents who moved away from Candidate A from their first opinion to their second opinion, as it is likely that the negative messages and endorsements influenced them to move away from their support of Candidate A.

### Determining Effectiveness Scores

The numerical values of the assessments of the messages by the movers are then computed to provide a single effectiveness score or metric that represents the effectiveness of each message in changing the opinion of the movers. Similarly, the numerical values of the assessments of the endorsements by the movers are then computed to provide a single effectiveness score or metric that represents the effectiveness of each endorsement in changing the opinion of the movers. The same methodology is used to calculate the effectiveness score for biographical information, provisions, or any other message type that may be used. Since the assessment of the message and endorsement pertained to how convincing the message or endorsement was, the numerical score provided by each mover is more likely to indicate which messages and endorsements helped to change their opinion. In one embodiment, the numerical values of the message and endorsement assessments provided by all of the respondents who moved toward voting for a candidate, as determined by the first opinion and the second opinion, are averaged to provide a mean score of the effectiveness of that message or endorsement. This mean score is the effectiveness, or movement score—the single metric which indicates the effectiveness of a message or endorsement. In another embodiment, the numerical value of the message assessments provided by all of the respondents who moved towards voting for a candidate, as determined by the first opinion and the second opinion, may be summed together to provide a total effectiveness score which shows the overall effectiveness of all the messages.

In one embodiment, the numerical values used to assess the messages and endorsements provide weighting which helps to more clearly distinguish convincing messages and endorsements from unconvincing messages and endorsements. Given the numerical values presented above for assessing the effectiveness of each message and endorsement, a message or endorsement with a higher numerical effectiveness score value indicates that it is more effective at changing a respondent's opinion than another message or endorsement with a lower score. Since the particular numerical scale provided in this example includes options for a negative 1 (−1) for an unconvincing message or endorsement, these unconvincing messages and endorsements will have statistically significantly lower scores than messages which were even somewhat convincing, as their mean or even total score is “punished” for being rated as unconvincing. This particular spectrum of negative, zero and positive numerical values provides for a weighting system of the effectiveness scores and provides a larger spread between effectiveness scores of persuasive and unpersuasive arguments.

The effectiveness scores may be multiplied by a factor of 10 or 100 to provide a larger number that can be more easily understood. For example, a person reading the effectiveness scores may more easily understand the difference between an effectiveness score on a scale of 100, such as scores of 38 and 58, than they would scores on a scale of 10, such as 3.8 and 5.8.

In one embodiment, the effectiveness scores may also be grouped into ranges which indicate broader levels of effectiveness. For example, scores of 0-74 may be considered ineffective, while scores of 75-129 may be considered somewhat effective, and scores of 130 or more are considered very effective. A negative score of below zero may indicate that a message is detrimental to a particular position statement. These ranges may be adjusted depending on the scale of effectiveness scores being used, or based on an overall understanding of the effectiveness scores over time.

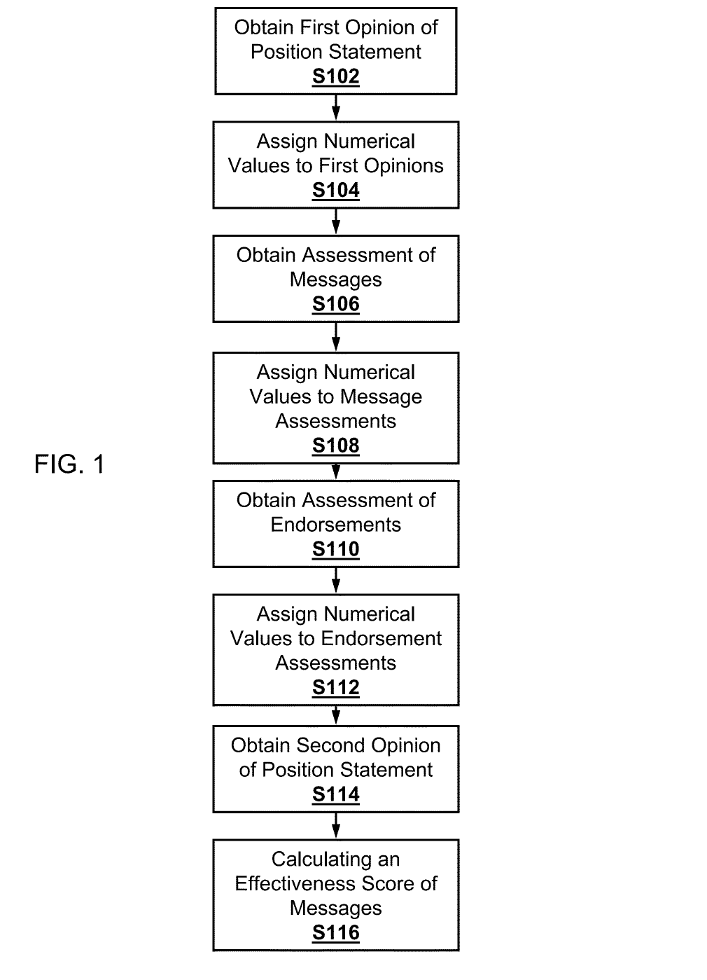

FIG. 1 illustrates one method of assessing the effectiveness of a message, according to one embodiment of the invention. In a first step S102, a first opinion on a position statement is obtained from a plurality of respondents participating in a particular public opinion survey. In step S104, a numerical value is assigned to each of the first opinions based on a numerical scale. Next, in step S106, a plurality of messages is presented to the respondents and the respondents assess how convincing each of the messages is to the participant on a scale from unconvincing to very convincing. In step S108, numerical values are assigned to the message assessments based on a numerical scale that corresponds to the levels of assessments selected by the users. Next, in step S110, a plurality of endorsements are presented to the respondents and the respondents assess how inclined they are to vote a certain way given each of the endorsements on a scale from much less inclined to much more inclined. In step S112, numerical values are assigned to the endorsement assessments based on a numerical scale that corresponds to the levels of assessments selected by the users. The respondents are then asked to provide a second opinion on the position statement in step S114. In step S116, an effectiveness score is then calculated for each message based on the numerical values provided by the respondents whose opinions on the position statement changed between the first opinion and the second opinion.

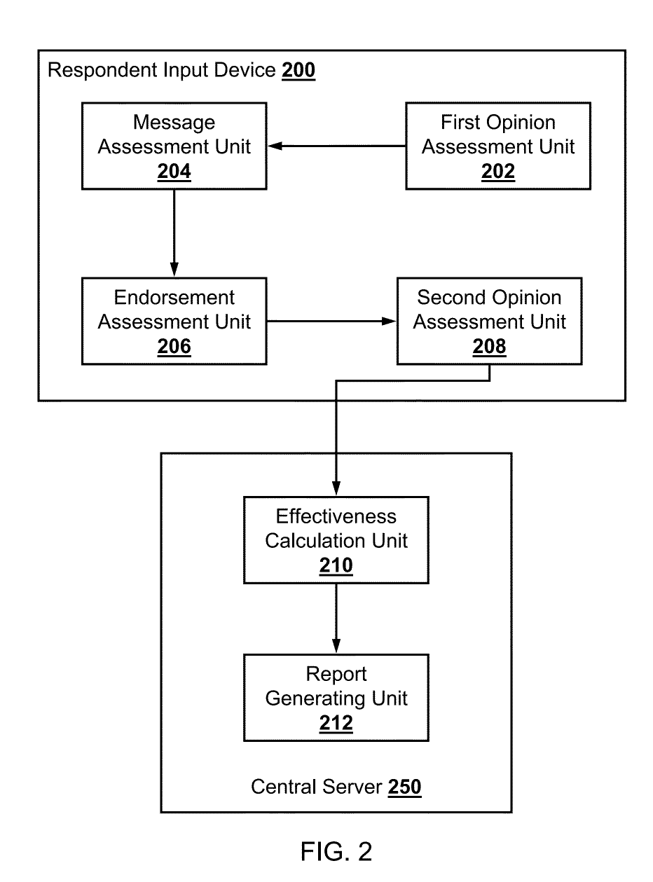

FIG. 2 illustrates one embodiment of a system for assessing the effectiveness of a message. The system described herein may be implemented on a computer or a network of computers designed to request input from survey respondents and transfer the received data to another computer which calculates and displays the effectiveness scores of the messages. In one embodiment, a participant input device 200 may be provided to allow the survey respondents to view the position statements and messages and input their opinions and message assessments. The respondent input device 200 may be a general purpose computer such as a desktop or laptop, or a portable electronic device such as a tablet or smartphone. The respondent input device 200 may display the first opinion, messages and second opinions to the respondents on a display or touchscreen, and receive their input from one or more input devices, such as a mouse, keyboard or touchscreen. The respondent input device 200 may be running software on the machine which generates graphical user interfaces (GUIs) that present the position statements and messages and request respondent responses, or the respondent input device 200 may access the GUIs as a web-based application which is hosted at a central server on a network and accessed through an Internet browser application on the respondent input device 200. Components of the respondent input device 200 may include a first opinion assessment unit 202 which displays the position statement and obtains a respondent's first opinion, a message assessment unit 204 which displays one or more messages to the respondent and receives the respondent's assessment of the messages, an endorsement assessment unit 206 which displays one or more endorsements to the respondent and receives the respondent's assessment of the endorsements, and a second opinion assessment unit 208 which displays the position statement a second time and obtains a respondent's second opinion.

The respondent input device 200 may then be connected, either directly or over a network, with a central server 250 which receives the assessment information on the respondent's opinions and message assessments and then calculates the effectiveness scores for each message. In one embodiment, an effectiveness calculation unit 210 receives the first opinions, second opinions and message assessments from all of the respondents of the survey and assigns them an appropriate numerical value corresponding to each of the opinions and assessments. The effectiveness calculation unit 210 may then identify the movers and calculate effectiveness scores for the messages. A report generating unit 212 may then compile the effectiveness scores and generate a report which details the messages evaluated and their effectiveness scores, in addition to any other relevant data, such as the position statement and the messages displayed to the respondents.

### Computer-Implemented Embodiment

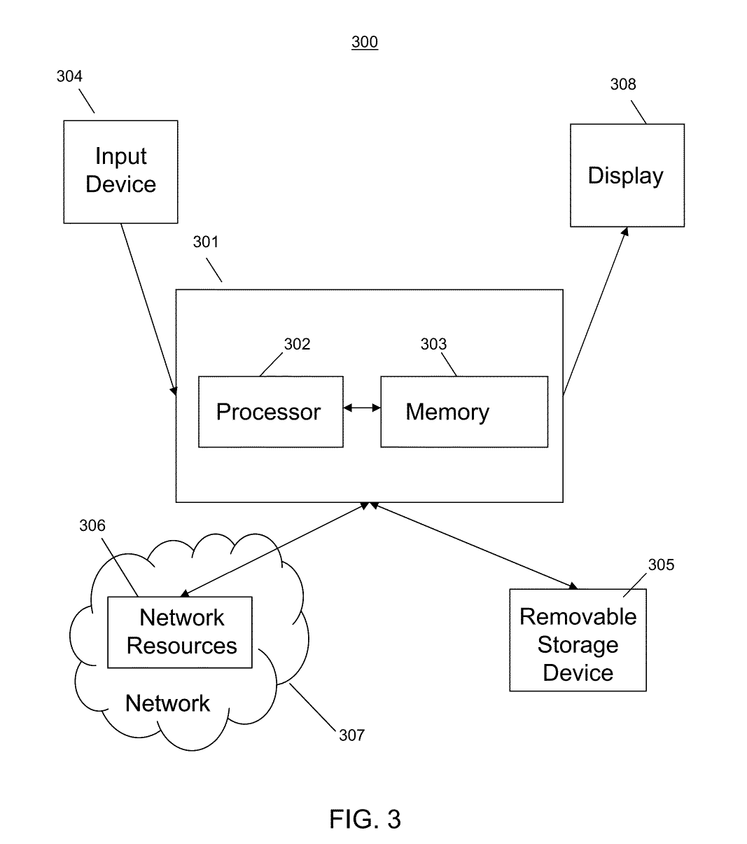

FIG. 3 is a block diagram that illustrates an embodiment of a computer/server system 300 upon which an embodiment of the inventive methodology may be implemented. The system 300 includes a computer/server platform 301 including a processor 302 and memory 303 which operate to execute instructions, as known to one of skill in the art. The term “computer-readable storage medium” as used herein refers to any tangible medium, such as a disk or semiconductor memory, that participates in providing instructions to processor 302 for execution. Additionally, the computer platform 301 receives input from a plurality of input devices 304, such as a keyboard, mouse, touch device or verbal command. The computer platform 301 may additionally be connected to a removable storage device 305, such as a portable hard drive, optical media (CD or DVD), disk media or any other tangible medium from which a computer can read executable code. The computer platform may further be connected to network resources 306 which connect to the Internet or other components of a local public or private network. The network resources 306 may provide instructions and data to the computer platform from a remote location on a network 307. The connections to the network resources 306 may be via wireless protocols, such as the 802.11 standards, Bluetooth® or cellular protocols, or via physical transmission media, such as cables or fiber optics. The network resources may include storage devices for storing data and executable instructions at a location separate from the computer platform 301. The computer interacts with a display 308 to output data and other information to a user, as well as to request additional instructions and input from the user. The display 308 may therefore further act as an input device 304 for interacting with a user.

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein

The above description of disclosed embodiments is provided to enable any person skilled in the art to make or use the invention. Various modifications to the embodiments will be readily apparent to those skilled in the art, the generic principals defined herein can be applied to other embodiments without departing from spirit or scope of the invention. Thus, the invention is not intended to be limited to the embodiments shown herein but is to be accorded the widest scope consistent with the principals and novel features disclosed herein.

What is claimed is:

1. A method of assessing the effectiveness of a message, comprising:
obtaining an first opinion from a plurality of respondents on a position statement;
assigning a numerical value to each of the first opinions from the plurality of respondents;
obtaining an assessment from the plurality of respondents of at least one message related to the position statement;
assigning a numerical value to each assessment of each message from the plurality of respondents;
obtaining a second opinion from the plurality of respondents on the position statement after the plurality of respondents have assessed the at least one message; and
calculating an effectiveness score of the at least one message based on the numerical values of the assessments provided by a number of respondents in the plurality of respondents whose opinions on the position statement changed from the first opinion to the second opinion.

2. The method of claim 1, further comprising:
obtaining an assessment from the plurality of respondents of at least one endorsement related to the position statement;
assigning a numerical value to each assessment of each endorsement from the plurality of respondents;
obtaining the second opinion from the plurality of respondents on the position statement after the plurality of respondents have assessed the at least one message and the at least one endorsement; and
calculating the effectiveness score of the at least one message and endorsement based on the numerical values of the assessment of the message and the assessment of the endorsement provided by a number of respondents in the plurality of respondents whose opinions on the position statement changed from the first opinion to the second opinion.

3. The method of claim 1, wherein the at least one message is intended to increase the respondent's agreement with the position statement, and wherein the effectiveness score of the at least one message is calculated based on the numerical values assigned to each assessment of the respondents whose second opinions increased their agreement with the position statement.

4. The method of claim 1, wherein the at least one message is intended to decrease the respondent's agreement with the position statement, and wherein the effectiveness score of the at least one message is calculated based on the numerical values assigned to each assessment of the respondents whose second opinions decreased their agreement with the position statement.

5. The method of claim 1, wherein a plurality of messages is presented to the respondents, and wherein:
a portion of the plurality of messages are positive messages intended to increase the respondents' agreement with the position statement;
a portion of the plurality of messages are negative messages intended to decrease the respondents' agreement with the position statement;
wherein the effectiveness scores of the positive messages are calculated based on the numerical values assigned to each assessment of the respondents whose second opinions increased their agreement with the position statement; and
wherein the effectiveness scores of the negative messages are calculated based on the numerical values assigned to each assessment of the respondents whose second opinions decreased their agreement with the position statement

6. The method of claim 1, wherein the first opinions are assigned one of five numerical values on a scale from 1 to 5.

7. The method of claim 6, wherein the assessments of each message are assigned one of four numerical values on a scale from −2 to 2.

8. The method of claim 7, wherein the effectiveness score of each message is calculated by averaging the numerical values assigned to each assessment by the plurality of respondents whose opinions changed from the first opinion to the second opinion.

9. The method of claim 8, wherein the effectiveness scores are classified into ranges of numerical values that identify the message as being effective, partially effective, not effective and detrimental.

10. A system for assessing the effectiveness of a message, comprising:
a first opinion assessment unit which obtains a first opinion from a plurality of respondents on a position statement and assigns a numerical value to each of the first opinions from the plurality of respondents;
a message assessment unit which obtains an assessment from the plurality of respondents of at least one message related to the position statement and assigns a numerical value to each assessment of each message from the plurality of respondents;
a second opinion assessment unit which obtains a second opinion from the plurality of respondents on the position statement after the plurality of respondents have assessed the at least one message; and
an effectiveness calculation unit which calculates an effectiveness score of the at least one message based on the numerical value of the assessments provided by a number of respondents in the plurality of respondents whose opinions on the position statement changed from the first opinion to the second opinion.

11. The system of claim 1, further comprising:
an endorsement assessment unit which obtains an assessment from the plurality of respondents of at least one endorsement related to the position statement and assigns a numerical value to each assessment of each endorsement from the plurality of respondents;
wherein the second opinion assessment unit obtains the second opinion from the plurality of respondents on the position statement after the plurality of respondents have assessed the at least one message and the at least one endorsement; and
wherein the effectiveness calculation unit calculates the effectiveness score of the at least one message and endorsement based on the numerical values of the assessment of the message and the assessment of the endorsement provided by a number of respondents in the plurality of respondents whose opinions on the position statement changed from the first opinion to the second opinion.

12. The system of claim 10, wherein the at least one message is intended to increase the respondent's agreement with the position statement, and wherein the effectiveness score of the at least one message is calculated based on the numerical values assigned to each assessment of the respondents whose second opinions increased their agreement with the position statement.

13. The system of claim 10, wherein the at least one message is intended to decrease the respondent's agreement with the position statement, and wherein the effectiveness score of the at least one message is calculated based on the numerical values assigned to each assessment of the respondents whose second opinions decreased their agreement with the position statement.

14. The system of claim 10, wherein a plurality of messages is presented to the respondents, and wherein:
a portion of the plurality of messages are positive messages intended to increase the respondents' agreement with the position statement;
a portion of the plurality of messages are negative messages intended to decrease the respondents' agreement with the position statement;
wherein the effectiveness scores of the positive messages are calculated based on the numerical values assigned to each assessment of the respondents whose second opinions increased their agreement with the position statement; and
wherein the effectiveness scores of the negative messages are calculated based on the numerical values assigned to each assessment of the respondents whose second opinions decreased their agreement with the position statement.

15. The system of claim 10, further comprising a report generating unit which compiles a plurality of effectiveness scores into a report displaying the effectiveness of the messages.

16. The system of claim 10, wherein the first opinions are assigned one of five numerical values on a scale from 1 to 5.

17. The system of claim 10, wherein the assessments of each message are assigned one of five numerical values on a scale from −2 to 2.

18. The system of claim 17, wherein the effectiveness score of each message is calculated by averaging the numerical values assigned to each assessment by the plurality of respondents whose opinions changed from the first opinion to the second opinion.

19. The system of claim 18, wherein the effectiveness scores are classified into ranges of numerical values that identify the message as being effective, partially effective and not effective.

20. A computer program product embodied on a computer-readable medium and comprising computer executable instructions for executing, on a computer with a processor and memory, a method of assessing the effectiveness of a message, comprising the steps of:
obtaining an first opinion from a plurality of respondents on a position statement;
assigning a numerical value to each of the first opinions from the plurality of respondents;
obtaining an assessment from the plurality of respondents of at least one message related to the position statement;
assigning a numerical value to each assessment of each message from the plurality of respondents;
obtaining a second opinion from the plurality of respondents on the position statement after the plurality of respondents have assessed the at least one message;
calculating an effectiveness score of the at least one message based on the numerical value of the assessments provided by a number of respondents in the plurality of respondents whose opinions on the position statement changed from the first opinion to the second opinion; and
displaying the effectiveness score of the at least one message on a display connected with the computer.
